(19) United States
(12) Patent Application Publication
(10) Pub. No.: US 2017/0151606 A1
(43) Pub. Date: Jun. 1, 2017

(54) MOLDING-MATERIAL SUPPLYING MECHANISM AND MOLDING APPARATUS

(71) Applicant: SEIKO EPSON CORPORATION, Tokyo (JP)

(72) Inventors: Yoshiro KOGA, Shiojiri-shi (JP); Takeshi MIYASHITA, Suwa-shi (JP); Tomoyuki KAMAKURA, Matsumoto-shi (JP)

(21) Appl. No.: 15/301,846

(22) PCT Filed: Apr. 10, 2015
(86) PCT No.: PCT/JP2015/002039

§ 371 Date: Oct. 4, 2016

(30) Foreign Application Priority Data
Apr. 11, 2014 (JP) 2014-081877

(51) Int. Cl. B22D 11/01; B29C 31/08; B33Y 30/00; B29C 67/00

(52) U.S. Cl. CPC B22D 11/01; B29C 67/0055; B29C 67/0085; B29C 31/08; B33Y 30/00

(57) ABSTRACT

To provide a molding-material supplying mechanism and a molding apparatus capable of improving a volume occupancy ratio of a molding material.

A cassette 61 (a molding-material supplying mechanism) includes a tape-like molding material 10 having a rectangular shape in section and a bobbin 616 (a winding core) on which the molding material 10 is wound. In sectional view orthogonal to a rotation axis of the bobbin 616 (the winding core), the molding material 10 is wound on the bobbin 616 (the winding core) in a concentric shape centering on the rotation axis.

### TECHNICAL FIELD

The present invention relates to a molding-material supplying mechanism and a molding apparatus.

### BACKGROUND ART

There has been known a molding apparatus (a so-called 3D printer) that generates a three-dimensional molded object on the basis of input data (see, for example, PTL 1).

The apparatus described in PTL 1 includes a substrate and a dispensing head. The substrate and the dispensing head are provided to be capable of moving relatively to each other. A string-like molding material (a flexible strand) is supplied to the dispensing head. The molding material is heated to a melting point in the dispensing head and dispensed from a nozzle of the dispensing head in a fluidized state. The string-like molding material is stored in a molding-material supplying mechanism in a state in which the string-like molding material is wound on a reel.

### CITATION LIST

### Patent Literature

PTL 1: JP-A-3-158228

### SUMMARY OF INVENTION

### Technical Problem

Incidentally, as described in PTL 1, a string-like or thread-like molding material has a circular shape in section or an elliptical shape in section. When such a molding material having the circular shape in section or the elliptical shape in section is wound on the reel, a gap is formed between windings of the wound molding material. Therefore, there is a problem in that a volume occupancy ratio of the molding material decreases by the volume of the gap.

An object of the present invention is to provide a molding-material supplying mechanism and a molding apparatus capable of improving a volume occupancy ratio of a molding material.

### Solution to Problem

A molding-material supplying mechanism of the present invention includes: a tape-like molding material having a rectangular shape in section; and a winding core on which the molding material is wound. In sectional view orthogonal to a shaft of the winding core, the molding material is wound on the winding core in a concentric shape centering on the shaft.

In the present invention, since the tape-like molding material is wound on the winding core, it is possible to wind the molding material on the winding core with a tape front surface on the winding core side and a tape rear surface on the opposite side of the winding core set close to each other. Therefore, compared with when the molding material having the circular shape in section or the elliptical shape in section is used and wound on the winding core, it is possible to improve a volume occupancy ratio of the molding material. Consequently, compared with when the molding material having the circular shape in section or the elliptical shape in section is used, it is possible to reduce a winding and storing space for the molding material and achieve a reduction in the size of the molding material mechanism.

In the molding-material supplying mechanism of the present invention, it is preferable that the molding-material supplying mechanism includes a brim section provided in at least one of both end portions in the axial direction of the winding core, an end edge in a tape width direction of the molding material coming into contact with the brim section.

In the present invention, since the end edge of the molding material comes into contact with the brim section, it is possible to regulate movement of the molding material in a tape width direction (i.e., the axial direction of the winding core). Consequently, it is possible to suppress positional deviation in the tape width direction of the molding material.

For example, even when stress is applied to the molding material from the tape width direction, the molding material wound in the concentric shape does not get loose from the winding core. It is possible to maintain the state in which the molding material is wound on the winding core. Therefore, it is possible to suppress inconveniences such as a meander during conveyance of the molding material. It is possible to stably supply the molding material.

In the molding-material supplying mechanism of the present invention, it is preferable that the molding-material supplying mechanism includes a rotation suppressing section that suppresses rotation of the winding core.

In the present invention, the rotation of the winding core is suppressed by the rotation suppressing section. In such a configuration, to rotate the winding core and draw out the molding material wound on the winding core, force necessary for drawing out the molding material has to be continuously applied to the molding material. Therefore, it is possible to suppress so-called idling in which, although the drawing force is not applied, the winding core rotates. It is possible to suppress an inconvenience of erroneous draw-out of the molding material.

In the molding-material supplying mechanism of the present invention, it is preferable that the molding-material supplying mechanism includes a housing that houses the molding material and the winding core.

In the present invention, the molding material and the winding core are housed in the housing. Consequently, it is possible to suppress the molding material wound on the winding core from getting loose against an intention of a user. It is possible to improve handleability. Further, it is possible to easily perform replacement of the molding material by attaching and detaching the housing to and from a molding apparatus.

In the molding-material supplying mechanism of the present invention, it is preferable that the housing includes a contact surface section to which the shaft of the winding core is turnably attached, the contact surface section being orthogonal to the shaft of the winding core and an end edge in a tape width direction of the molding material coming into contact with the contact surface section.

In the present invention, it is possible to regulate movement in the tape width direction of the molding material with the contact surface section with which the end edge of the molding material comes into contact.

In the molding-material supplying mechanism of the present invention, it is preferable that the molding-material supplying mechanism includes a guide member that guides the molding material drawn out from the winding core, the housing includes a feeding port for feeding the molding material to the outside of the housing and a guide surface section provided between the guide member and the feeding port on the inner surface of the housing, and the guide member guides the molding material in a direction in which an end edge in a tape width direction of the molding material is brought into contact with the guide surface section.

In the present invention, the molding material is conveyed to the guide surface section side by the guide member. The end portion of the molding material comes into contact with the guide surface section. Consequently, the molding material is fed from the feeding port in a state in which the end portion is in contact with the guide surface section and guided. Therefore, the molding material fed from the feeding port does not move in the tape width direction and meander. It is possible to perform stable supply of the molding material.

In the molding-material supplying mechanism of the present invention, it is preferable that the guide member is a guide roller having an outer circumference columnar shape capable of rotating about a rotating shaft, the guide roller rotating in a state in which a surface orthogonal to a tape thickness direction of the molding material is set in contact with the outer circumferential surface to guide the molding material in a direction in which the molding material is brought into contact with the guide surface section, and the rotating shaft inclines from the normal direction of the guide surface section to a conveying direction side in which the molding material is conveyed to the feeding port side.

In the present invention, the rotating shaft of the guide roller is inclined to the conveying direction side with respect to the normal direction of the guide surface section. In such a configuration, simply by bringing the molding material into contact with the outer circumferential surface of the guide roller, the molding material moves to the guide surface section side with an urging force during the guide roller rotation. The edge portion in the tape width direction of the molding material comes into contact with the guide surface section. Therefore, as explained above, it is possible to perform stable supply of the molding material with a simple configuration.

In the molding-material supplying mechanism of the present invention, it is preferable that the molding-material supplying mechanism includes a winding-curl adjusting section that adjusts a winding curl of the molding material.

The adjusting the winding curl means adjusting the winding curl to desired strength and includes removing the winding curl.

The molding material wound on the winding core sometimes has different strength of the winding curl according to the distance from the center axis of the winding core, that is, a curvature. In the present invention, it is possible to adjust the strength of the winding curl. Therefore, it is possible to suppress deterioration in conveyance stability due to fluctuation in the strength of the winding curl. It is possible to stably convey and supply the molding material.

In the molding-material supplying mechanism of the present invention, it is preferable that the winding-curl adjusting section includes a contact surface with which a surface orthogonal to the thickness direction of the molding material comes into contact in a predetermined distance along a conveying direction.

In the present invention, the winding-curl adjusting section brings a tape front surface orthogonal to the thickness direction of the molding material into contact with the contact surface in the predetermined distance. In such a configuration, it is possible to adjust the strength of the winding curl to strength corresponding to a surface shape of the contact surface while the molding material is conveyed along the contact surface.

In the molding-material supplying mechanism of the present invention, it is preferable that the contact surface has a predetermined curvature with respect to the conveying direction of the molding material.

In the present invention, the contact surface has the predetermined curvature in the conveying direction crossing the width direction of the molding material. In such a configuration, it is possible to adjust the strength of the winding curl of the molding material to strength corresponding to the curvature of the contact surface.

In the molding-material supplying mechanism of the present invention, it is preferable that the molding material has flexibility, and an aspect ratio of a tape thickness dimension and a tape width dimension in sectional view is equal to or larger than 10.

In the present invention, the aspect ratio (the tape width dimension/the tape thickness dimension) is equal to or larger than 10. When the aspect ratio is smaller than 10, it is conceivable that the tape thickness dimension is too large with respect to the tape width dimension or the tape width dimension is too small with respect to the tape thickness dimension. In the former case, since the flexibility of the molding material is insufficient and the tape thickness dimension is too large, sufficient flexibility is not obtained and conveyance handleability of the molding material by a feeding mechanism is deteriorated. In the latter, a twist or the like occurs and the conveyance handleability is deteriorated. On the other hand, by setting the aspect ratio to be equal to or larger than 10 as explained above, it is possible to improve conveyance efficiency of the molding material having the flexibility. It is possible to efficiently convey the molding material to a desired molding position.

A molding apparatus of the present invention includes: a molding-material supplying mechanism that supplies a molding material; a feeding mechanism that conveys the molding material to a molding position on a stage; a melting mechanism that melts the molding material conveyed to the molding position; and a moving mechanism that moves the molding position relatively to the stage. The molding-material supplying mechanism includes: a tape-like molding material having a rectangular shape in section; and a winding core on which the molding material is wound. In sectional view orthogonal to a shaft of the winding core, the molding material is wound on the winding core in a concentric shape centering on the shaft.

In the present invention, as in the invention of the molding-material supplying mechanism, compared with when the molding material having the circular shape in section or the elliptical shape in section is wound on the winding core, it is possible to improve a volume occupancy ratio of the molding material. Consequently, compared with when the molding material having the circular shape in section or the elliptical shape in section is used, it is possible to reduce a winding and storing space for the molding material and achieve a reduction in the size of the molding material mechanism and the molding apparatus.

In the molding apparatus of the present invention, it is preferable that the feeding mechanism conveys the molding material to the molding position with a surface on the winding core side in the molding material, which is wound on the winding core, opposed to the stage side.

In the present invention, the molding material is supplied and conveyed such that a surface on the winding core side (hereinafter referred to as first surface as well) of the molding material wound on the winding core is opposed to the stage side. Consequently, the molding material is conveyed to the molding position on the stage in a state in which the distal end of the molding material has a winding curl in a direction toward the stage. Therefore, it is possible to suppress an inconvenience that the molding material conveyed to the molding position is turned up in a direction away from the stage and a molded object on the stage. It is possible to accurately melt and laminate the molding material in a predetermined molding position.

In the molding apparatus of the present invention, it is preferable that the feeding mechanism includes a pair of rollers that holds and conveys the molding material, and, of the pair of rollers, one roller in contact with a surface on the winding core side of the molding material wound on the winding core is driven to rotate.

In the present invention, of the pair of rollers, the roller in contact with the first surface of the molding material is driven to rotate. Consequently, the molding material is urged by a winding curl to a side of the roller driven to rotate. It is possible to suppress a slip or the like during the conveyance. It is possible to improve conveyance efficiency.

In the molding apparatus of the present invention, it is preferable that the molding-material supplying mechanism includes a pair of rollers that holds and conveys the molding material, the pair of rollers is driven to rotate, and, of the pair of rollers, one roller in contact with a surface on the winding core side of the molding material wound on the winding core has rotating speed higher than rotating speed of the other roller in contact with a surface on the opposite side of the winding core of the molding material wound on the winding core.

In the present invention, the pair of rollers is respectively driven to rotate to hold and convey the molding material. In this case, rotating speed of the roller in contact with a first surface of the molding material (i.e., the driving roller to which the molding material is urged by the winding curl) is set higher than rotating speed of the roller in contact with a second surface on the opposite side of the first surface. Consequently, it is possible to cause stress in a direction in which the first surface side is extended in the conveying direction to correct the winding curl to act on the first surface from the roller in contact with the first surface. Therefore, it is possible to correct the winding curl of the molding material.

### BRIEF DESCRIPTION OF THE DRAWINGS

FIG. 1 is a diagram showing the schematic configuration of a molding apparatus in an embodiment.

FIG. 2 is a perspective view showing the schematic configuration of a molding material used in the embodiment.

FIG. 3 is a front view showing the schematic configuration of a cassette in the embodiment.

FIG. 4 is a sectional view showing the schematic configuration of the cassette in the embodiment.

FIG. 5 is a sectional view showing the schematic configuration of a gas supplying section in the embodiment.

FIG. 6 is a diagram showing a distal end shape of a nozzle in a heat resistant syringe.

FIG. 7 is a diagram showing a configuration example of a swinging section for scanning the gas supplying section in a tape width direction.

FIG. 8 is a flowchart showing a molding method (molding processing) for molding a molded object using the molding apparatus in the embodiment.

FIG. 9 is a perspective view showing a process in which the molded object is formed by the molding processing in the embodiment.

FIG. 10 is a perspective view showing a storage configuration for a molding material in another embodiment.

### DESCRIPTION OF EMBODIMENTS

A molding apparatus in an embodiment according to the present invention is explained below with reference to the drawings.

### [Schematic Configuration of the Molding Apparatus]

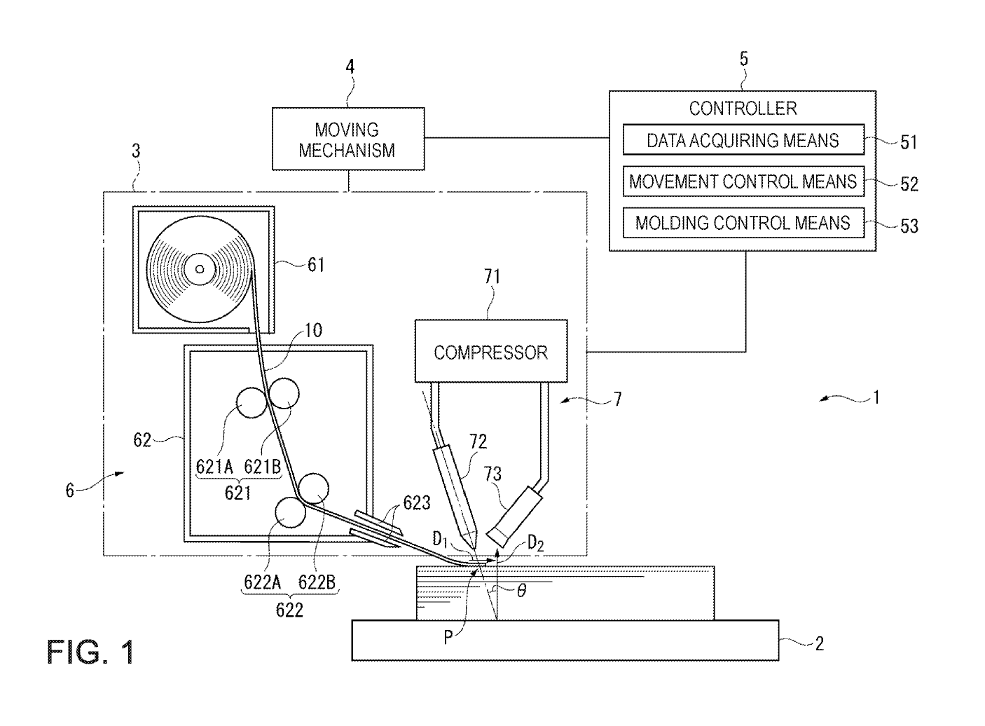

FIG. 1 is a diagram showing the schematic configuration of the molding apparatus in this embodiment.

As shown in FIG. 1, a molding apparatus 1 (a laminate molding apparatus) includes a stage 2, a molding head 3, a moving mechanism 4, and a controller 5.

The molding apparatus 1 is an apparatus that laminates a molding material on the stage 2 and molds a three-dimensional molded object according to a sectional shape of data for molding input to the controller 5 from a data output apparatus such as a personal computer. Specifically, the controller 5 controls the moving mechanism 4 on the basis of the data for molding and moves the molding head 3 to a predetermined molding position P. The controller 5 controls the molding head 3 and melts and laminates a molding material 10 in the molding position P on the stage 2.

The components are explained in detail below.

### [Configuration of the Stage 2]

The stage 2 is a pedestal for molding a molded object and includes, for example, a plane on which the molded object is placed.

### [Configuration of the Molding Head 3]

The molding head 3 is provided to be capable of being moved with respect to the stage 2 by the moving mechanism 4. The molding head 3 includes, as shown in FIG. 1, a tape conveying mechanism 6 and a hot-air blowing mechanism 7 equivalent to the melting mechanism of the present invention.

### [Configuration of the Tape Conveying Mechanism 6]

The tape conveying mechanism 6 includes a cassette 61 that is equivalent to the molding-material supplying mechanism of the present invention and stores and supplies the molding material 10 and a feeding section 62 that is equivalent to the feeding mechanisms of the present invention and conveys the molding material 10, which is supplied from the cassette 61, to the predetermined molding position P on the stage 2.

### (Configuration of the Molding Material 10)

The molding material 10 stored in the cassette 61 is explained.

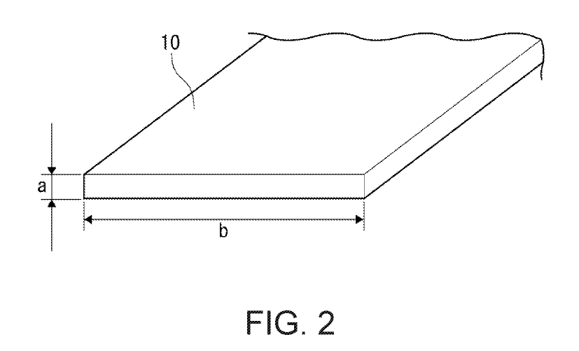

FIG. 2 is a perspective view showing the schematic configuration of the molding material 10 used in this embodiment.

As shown in FIG. 2, the molding material 10 includes a flat cross section having a short side (a tape thickness dimension) “a” and a long side (a tape width dimension) “b”. The molding material 10 is configured in a thin shape (a tape shape) having an aspect ratio (b/a) equal to or larger than 10. When the aspect ratio is smaller than 10, conveyance handleability of the molding material 10 is deteriorated. That is, when the tape thickness dimension “a” is increased with respect to the tape width dimension “b”, flexibility of the molding material 10 is deteriorated, whereby conveyance efficiency in a feeding roller pair 621 and a driving roller pair 622 explained below is deteriorated and handleability (easiness of conveyance) is deteriorated during conveyance. In this embodiment, a surface (a tape rear surface) on the stage 2 side of the molding material 10 and the upper surface of molded object in the molding position P (or the surface of the stage 2) are brought into contact with each other making use of the flexibility of the molding material 10. Therefore, when the molding material 10 does not have sufficient flexibility, in the molding position P, a gap is formed between the upper surface of the molded object (or the surface of the stage 2) and the tape rear surface of the molding material 10. Adhesion at the time when the molding material 10 is melted is deteriorated. Even when the tape thickness dimension “a” is sufficiently small, if the tape width dimension “b” is small, it is likely that a twist occurs in the molding material 10 during conveyance. Conveyance handleability is deteriorated.

On the other hand, by setting the aspect ratio to be equal to or larger than 10 as explained above, it is possible to improve conveyance efficiency of the molding material 10 having flexibility. It is possible to efficiently convey the molding material to a desired molding position.

As such a molding material 10, metal, resin, and the like can be illustrated.

When metal is used as the molding material 10, the strength of a molded object obtained by molding is higher than the strength of a molded object molded from resin. On the other hand, the molding material 10 needs to be conveyed to the molding position P on the stage 2. Flexibility of the molding material 10 is required. In the molding material 10 made of metal, it is desirable to set the tape thickness dimension to a≦0.1 mm in order to secure the flexibility. When the tape thickness dimension is a>0.1 mm, the molding material 10 less easily bends. It is difficult to convey the molding material 10 to the desired molding position P during conveyance.

The tape width dimension “b” is set taking into account the conveyance handleability as explained above. When the tape thickness dimension “a” is 0.1 mm, the tape width dimension is desirably set to be equal to or larger than 1 mm. Note that, depending on a set value of the tape thickness dimension “a”, a set value of the tape width dimension “b” is more desirably set to 5 mm≦b≦15 mm. In the tape-like molding material 10 formed in the dimensions “a” and “b” explained above, it is possible to maintain sufficient flexibility and it is possible to suppress deterioration in handleability due to a twist or the like.

When the molding material 10 made of metal is used, it is more desirable to use Mg. Mg has small specific gravity compared with, for example, Al (whereas Mg specific gravity is 1.7, Al specific gravity is 2.7). It is possible to achieve a reduction in the weight of the molding material 10.

Further, the molding material 10 made of metal is desirably applied with flameproof treatment or fireproof treatment to prevent oxidation from occurring when the molding material 10 is heated to near a melting point. As the flameproof treatment and the fireproof treatment, publicly-known techniques can be used.

It is possible to manufacture the molding material 10 made of metal explained above in a large volume and inexpensively by cutting a material molded by rolling or extrusion.

On the other hand, when resin is used as the molding material 10, a melting point is low compared with metal. It is possible to set a heating temperature of gas in the hot-air blowing mechanism 7 explained below low. It is possible to achieve further simplification of the heating mechanism. When such a molding material 10 made of resin is used, it is desirable to set the tape thickness dimension to a≦1 mm and set the tape width dimension to 5 mm≦c. In the molding material 10 made of resin, flexibility is easily secured and a thickness dimension can be increased compared with metal. However, when the tape thickness dimension is a>1 mm, flexibility is insufficient and handleability is deteriorated. When the tape width dimension is 5 mm>b, a twist easily occurs and handleability is deteriorated. Consequently, it is desirable to configure the molding material 10 such that the aspect ratio is equal to or larger than 10 in the ranges of the dimensions “a” and “b” explained above.

### (Configuration of the Cassette 61)

The cassette 61 of the tape conveying mechanism 6 is specifically explained.

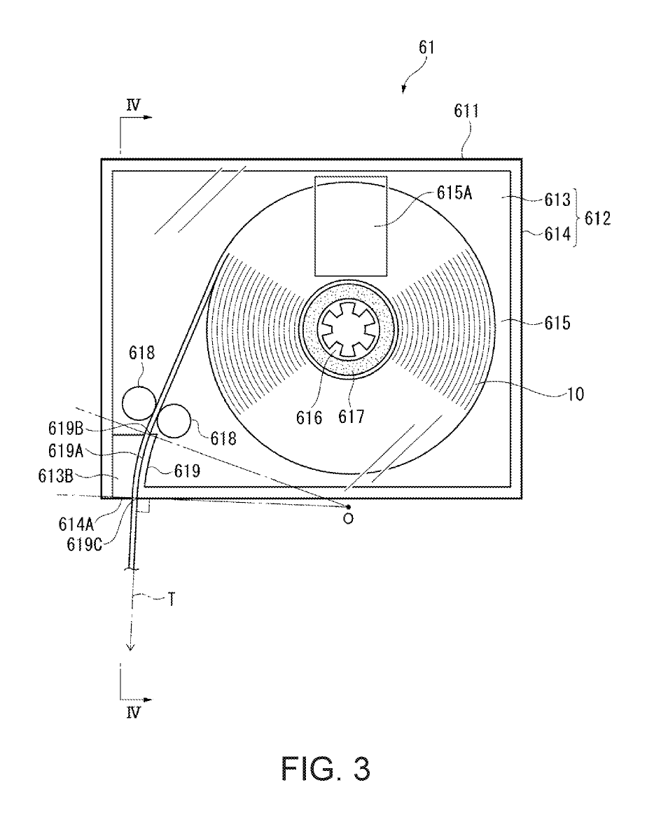

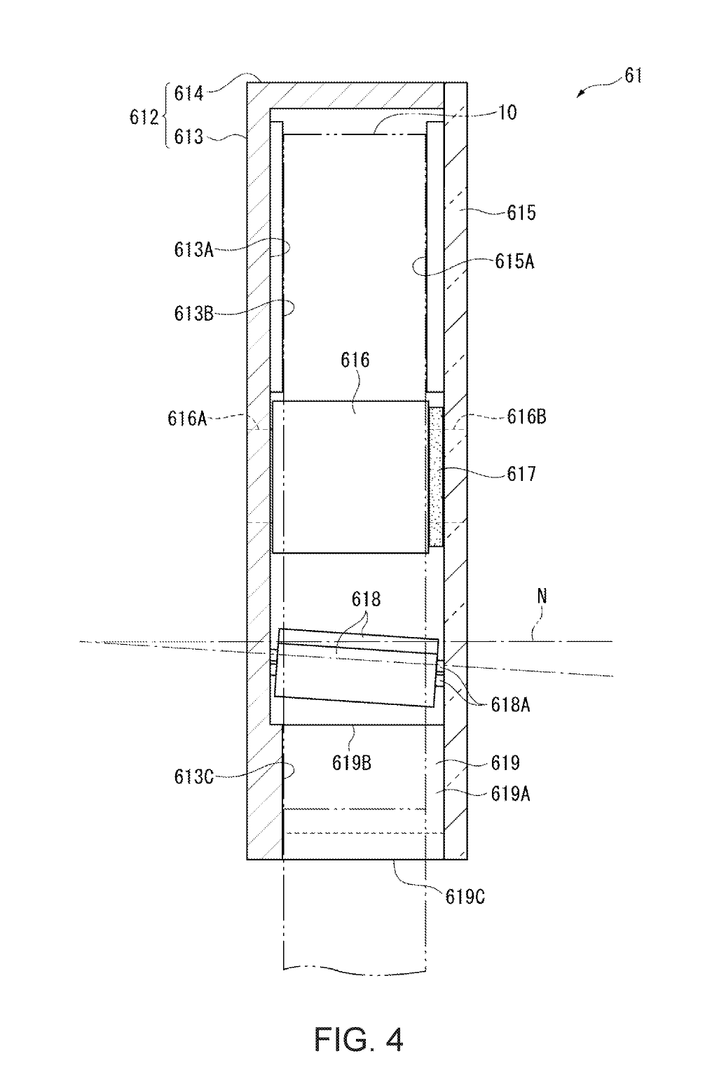

FIG. 3 is a front view showing the schematic configuration of the cassette 61 in this embodiment. FIG. 4 is a sectional view showing the schematic configuration of the cassette 61 in this embodiment taken along line IV-IV in FIG. 3.

Note that FIG. 4 shows the cassette 61 taken along a surface orthogonal to an inner surface 613A explained below of a case 611 and passing a feeding port 614A for the molding material 10 and viewed toward the tape front surface of the molding material 10. The molding material 10 is indicated by an alternate long and two short dashes line.

As shown in FIG. 3 and FIG. 4, the cassette 61 includes the case 611 equivalent to the housing of the present invention, a bobbin 616 equivalent to the winding core of the present invention, a rotation suppressing section 617, guide rollers 618 equivalent to the guide member of the present invention, and a winding-curl adjustment guide 619 equivalent to the winding-curl adjusting section of the present invention.

The case 611 has, for example, a rectangular parallelepiped shape including an internal space. The bobbin 616 and the molding material 10 wound on the bobbin 616 are housed in the case 611.

The case 611 includes a case main body 612 and a lid body 615. The case main body 612 includes a base section 613 having a rectangular flat shape and a wall section 614 that stands from the outer peripheral portion of the base section 613 and surrounds the periphery of one surface 613A (hereinafter referred to as inner surface 613A as well) of the base section 613.

The lid body 615 is attached to an end face of the wall section 614 on the opposite side of the base section 613. The lid body 615 is attached to the case 611 in this way, whereby an internal space is formed. In this embodiment, the lid body 615 is formed of a transparent member. Consequently, a state on the inside can be observed from the outside.

The feeding port 614A is provided in a part (in this embodiment, a corner of a rectangular parallelepiped) of the wall section 614. The molding material 10 stored on the inside is taken out to the outside from the feeding port 614A.

The case 611 includes, as shown in FIG. 4, a first contact surface section 613B and a guide surface section 613C provided in the base section 613 and a second contact surface section 615A provided in the lid body 615. The first contact surface section 613B and the guide surface section 613C come into contact with the end edge in the width direction of the molding material 10 wound on the bobbin 616 and regulate movement in the width direction of the end edge.

The first contact surface section 613B is formed on the inner surface 613A of the base section 613 and projects toward the lid body 615 side. A side surface (one end edge in the tape width direction) of the molding material 10 wound on the bobbin 616 is brought into contact with an end face of the first contact surface section 613B opposed to the lid body 615.

The guide surface section 613C is provided in a predetermined region on an upstream side in a conveying direction of the molding material 10 from the feeding port 614A on the inner surface 613A and projects toward the lid body 615 side. The end edge in the tape width direction of the molding material 10 fed from the bobbin 616 and passing the feeding port 614A is brought into contact with an end face of the guide surface section 613C opposed to the lid body 615. In a state in which the movement in the tape width direction is regulated, the guide surface section 613C guides a feeding direction of the molding material 10. The guide surface section 613C is desirably flush with the end face of the first contact surface section 613B.

The second contact surface section 615A is provided to be opposed to the first contact surface section 613B, for example, in a position spaced apart from the end face of the first contact surface section 613B by the tape width dimension “b” of the molding material 10. The second contact surface section 615A comes into contact with the end edge on the lid body 615 side of the molding material 10, which is wound on the bobbin 616, from the opposite side of the first contact surface section 613B and regulates movement in the width direction of the end edge.

The bobbin 616 is a shaft-like member equivalent to the winding core of the present invention. As shown in FIG. 4, both end portions 616A and 616B in a direction along a rotation axis are respectively rotatably supported by the base section 613 and the lid body 615 opposed to each other. One end portion of the molding material 10 explained above is fixed to the bobbin 616. The molding material 10 is wound along the circumferential surface of the bobbin 616. More specifically, the tape-like molding material 10 is wound in a concentric shape and stored in a roll shape such that a tape rear surface (a surface opposed to the stage 2 when the molding material 10 is conveyed onto the stage 2) adheres to a tape front surface (a surface on the opposite side of the tape rear surface) of the molding material 10 wound on the bobbin 616.

In such a configuration, a volume occupancy ratio is high compared with, for example, when a molding material having a circular shape in section is wound on the bobbin 616. Therefore, when the molding material having the circular shape in section and the tape-like molding material 10 in this embodiment are wound on the bobbin by the same amount, it is possible to reduce a volume when the molding material 10 in this embodiment is used compared with when the molding material having the circular shape in section is used. It is possible to achieve a reduction in the size of the cassette 61. Further, since the number of windings on the bobbin 616 is smaller as well, manufacturing efficiency is also satisfactory. When a size of the cassette 61 is specified, since a volume occupancy ratio is large when the tape-like molding material 10 in this embodiment is used, it is possible to store a larger amount of the molding material 10 in the cassette 61 compared with when the molding material having the circular shape in section is used.

The rotation suppressing section 617 is configured in, for example, a cylindrical shape coaxial with the center axis of the bobbin 616 as shown in FIG. 3 and is provided on the inner surface of the lid body 615 as shown in FIG. 4. The rotation suppressing section 617 comes into contact with a side surface on the lid body 615 side of the bobbin 616 and applies a frictional force to the side surface. As the rotation suppressing section 617, felt, an elastic member made of resin, can the like can be used.

In order to rotate the bobbin 616 with the rotation suppressing section 617, it is necessary to cause a rotational force resisting the frictional force to act on the bobbin 616. It is possible to suppress idling of the bobbin 616. In order to draw out the molding material 10 from the cassette 61, a conveyance driving force (a tensile force) equal to or larger than the frictional force is applied to the molding material 10. That is, unless the tensile force equal to or larger than the frictional force acts, the molding material 10 is not drawn out. Consequently, it is possible to suppress the molding material 10 from being erroneously drawn out. It is possible to more appropriately adjust a draw-out amount of the molding material 10. Therefore, it is possible to suppress occurrence of a meander and skew of the molding material 10 and slack and a crease due to the slack. It is possible to stably supply the molding material 10.

The guide rollers 618 are provided in the vicinity of the feeding port 614A and on the upstream side in the conveying direction of the winding-curl adjustment guide 619. The guide rollers 618 guide the conveying direction of the molding material 10. A pair of guide rollers 618 is provided. The molding material 10 is pinched and fed by the pair of guide rollers 618 and guided to the winding-curl adjustment guide 619. The guide rollers 618 include, as shown in FIG. 4, rotating shafts 618A that further incline to the conveying direction side with respect to a normal direction N of the inner surface 613A as the rotating shafts 618A are further away from the inner surface 613A. The guide rollers 618 guide one end edge in the tape width direction of the molding material 10 in a direction in which the one end edge is pressed against the guide surface section 613C. Therefore, the molding material 10 is drawn out from the feeding port 614A in a state in which the end edge in the tape width direction is set in contact with the guide surface section 613C.

Note that, since the molding material 10 is pinched by the guide rollers 618, it is possible to suppress slack of the wound molding material 10. Traveling performance (conveying performance) of the molding material 10 fed from the feeding port 614A is improved.

The winding-curl adjustment guide 619 includes, as shown in FIG. 3, a contact surface 619A provided in the vicinity of the feeding port 614A, orthogonal to the inner surface 613A of the base section 613, and in contact with the tape rear surface of the molding material 10. The contact surface 619A is a curved surface having a predetermined curvature set in advance to make a side in contact with the tape rear surface of the molding material 10 convex in sectional view in a surface parallel to the inner surface 613A. Note that, in FIG. 3, an example of a curvature center O is shown.

In this embodiment, the guide rollers 618 are disposed on a tangential line at an end portion 619B on the upstream side of the contact surface 619A in the conveying direction. The molding material 10 fed from the guide rollers 618 is conveyed along the tangential line. Consequently, it is possible to guide the molding material 10, which is fed from the guide rollers 618, to the end portion 619B.

The winding-curl adjustment guide 619 is configured such that a tangential direction T (see FIG. 3) at an end portion 619C on the conveying direction downstream side coincides with a drawing-out direction of the molding material 10 by the feeding section 62 explained below. With the configuration explained above, it is possible to convey the molding material 10 from the end portion 619B on the upstream side to the end portion 619C on the downstream side in the conveying direction in a state in which the molding material 10 is placed along the contact surface 619A.

Therefore, in the winding-curl adjustment guide 619, since the molding material 10 is drawn out by the feeding section 62, the tape rear surface of the molding material 10 comes into contact with the end portions 619B to 619C of the contact surface 619A. A winding curl of the molding material 10 is adjusted (corrected) to size corresponding to a curvature set in the contact surface 619A.

As explained above, as the position during winding in the bobbin 616 is closer to the rotation center of the bobbin 616, the curvature of the molding material 10 is larger and the winding curl is also larger. Conversely, as the position during the winding is farther from the rotation center of the bobbin 616, the curvature of the molding material 10 is smaller and the winding curl is also smaller. When the size of the winding curl of the molding material 10 is different according to such a position during the winding, it is likely that deficiencies during conveyance occur, for example, the magnitude of a frictional force between the molding material 10 and a roller configuring a conveying mechanism in the feeding section 62 explained below fluctuates and the distal end position of the molding material 10 cannot be adjusted to a desired position when the frictional force increases. In this embodiment, the molding material 10 is conveyed along the contact surface 619A in a state in which the molding material 10 is set in contact with the contact surface 619A having the predetermined curvature. Consequently, the winding curl of the molding material 10 is adjusted to a value corresponding to the predetermined curvature.

Note that the curvature and the dimension in the conveying direction of the contact surface 619A only have to be set according to the material, the shape, and the like of the molding material 10 such that the size of the winding curl of the molding material 10 can be set to a value in a desired range.

In the cassette 61 configured as explained above, for example, positioning sections by locking pins, guide protrusions, and the like not shown in the figure are provided on an exterior section of the case 611. By positioning the positioning sections in predetermined positions in the molding head 3, it is possible to mount the cassette 61 on the molding head 3.

### (Configuration of the Feeding Section 62)

As shown in FIG. 1, the feeding section 62 feeds the molding material 10, which is provided from the cassette 61, to the molding position P on the stage 2.

The feeding section 62 includes a feeding roller pair 621 configured by a pair of feeding rollers 621A and 621B, a driving roller pair 622 configured by a driving roller 622A and a driven roller 622B, and a guide section 623. Note that, in this embodiment, an example is explained in which one feeding roller pair 621 is provided. However, two or more feeding roller pairs 621 may be provided. A configuration may be adopted in which the feeding roller pair 621 is not provided and only the driving roller pair 622 is provided. Further, an example is explained in which only one driving roller pair 622 is provided. However, a configuration may be adopted in which two or more driving roller pairs 622 are provided.

The feeding roller pair 621 pinches the molding material 10 with the feeding rollers 621A and 621B and guides conveyance of the molding material 10. The feeding roller pair 621 conveys the molding material 10 while curving the molding material 10 to the opposite side of a winding curl (a winding direction on the bobbin 616) of the molding material 10 fed from the cassette 61. Consequently, it is possible to correct the winding curl of the molding material 10.

The driving roller pair 622 is equivalent to the pair of conveying rollers of the present invention. The driving roller pair 622 draws in the molding material 10 and feeds the molding material 10 toward the molding position P. Specifically, the driving roller pair 622 includes a driving roller 622A driven to rotate by a driving force of a motor or the like and a driven roller 622B (to which the motor driving force is not transmitted) that follows the driving of the driving roller 622A. Conveyance at constant speed of the molding material 10 is enabled by the driving roller 622A and the driven roller 622B.

The driving roller 622A is desirably in contact with the tape rear surface of the molding material 10. Consequently, the molding material 10 is urged to the driving roller 622A by the winding curl of the molding material 10. It is possible to suppress a slip or the like during conveyance. It is possible to improve conveyance efficiency. Note that a configuration may be adopted in which the driving roller 622A is in contact with the tape front surface.

A configuration may be adopted in which both of the pair of rollers configuring the driving roller pair 622 are driven as driving rollers. In this case, rotating speed of the driving roller in contact with the tape rear surface is slightly increased with respect to rotating speed of the driving roller in contact with the tape front surface. Then, a tensile force acts on the tape rear surface. It is possible to correct the winding curl of the molding material 10.

The guide section 623 is configured in, for example, a leaf spring shape from a metal material having high durability, the surface of which is subjected to wear resistant treatment. The guide section 623 includes guide walls (not shown in the figure) at both ends along the conveying direction.

The guide section 623 removes the slack of the molding material 10, corrects the conveying direction of the molding material 10, and guides the conveyance to the molding position P on the stage 2.

In the molding material 10 guided by the guide section 623, the distal end portion is urged to be brought into contact with the molding position P by a bend. A portion heated by the hot-air blowing mechanism 7 explained below is melted and laminated on the molding position P.

### [Configuration of the Hot-Air Blowing Mechanism 7]

The hot-air blowing mechanism 7 includes, as shown in FIG. 1, a compressor 71, a gas supplying section 72, and a duct 73.

### [Configuration of the Compressor 71]

The compressor 71 is an apparatus that includes a compression space (not shown in the figure) for compressing gas to high pressure and supplies the gas to the gas supplying section 72 with the pressure. As the gas, it is desirable to use an inert gas. By using the inert gas, it is possible to prevent degeneration of the molding material 10 at the time when the molding material 10 is heated.

A dehumidifying agent for removing moisture in the gas is provided on the inside of the compressor 71. The gas supplied from the compressor 71 is dehumidified. Therefore, even when the air is used as the gas, dehumidified heated air is blown against the molding material 10. It is possible to suppress reaction of the molding material 10 and water.

Note that the compressor 71 is connected to the duct 73. The gas sucked by the duct 73 is led into the compression space.

In this embodiment, when the inert gas is used as the gas, it is desirable to maintain the stage 2 under an inert gas atmosphere. Specifically, at least the stage 2, the molding head 3, and the moving mechanism 4 of the molding device 1 are housed in a closed molding chamber. The molding chamber is maintained under the inert gas atmosphere. Consequently, the inert gas is sucked by the duct 73. It is possible to always blow the inert gas against the molding material 10.

Note that, when the dehumidified air is used as the gas, it is unnecessary to maintain the molding chamber under the inert gas atmosphere. The molding chamber does not have to be provided.

### (Configuration of the Gas Supplying Section 72)

The gas supplying section 72 heats the gas supplied from the compressor 71 and blows the heated gas against the molding position P. The gas supplying section 72 is disposed to incline at a predetermined angle θ with respect to a normal direction D₂ of the stage 2 within a surface including a conveying direction D₁ and the normal direction D₂ such that the heated gas blown from the gas supplying section 72 flows from the upstream side to the downstream side of the molding material 10 conveyed along the conveying direction. The inclination angle θ is suitably, for example, 0°<θ≦45°. Consequently, the heated gas does not flow to the upstream side of the molding material 10. It is possible to avoid an inconvenience that the molding material 10 in a position other than the molding position P is melted.

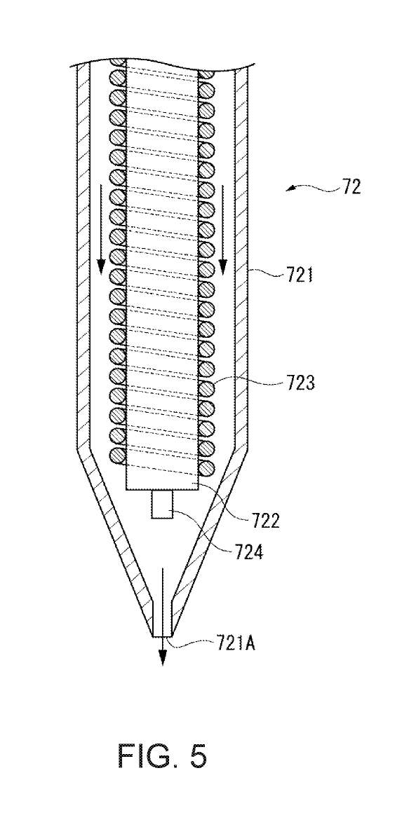

FIG. 5 is a sectional view showing the schematic configuration of the gas supplying section 72.

As shown in FIG. 5, the gas supplying section 72 includes a heat resistant syringe 721, a winding core 722, a heater coil 723, and a temperature sensor 724.

The heat resistant syringe 721 is formed in a cylindrical shape such as a columnar shape. The heat resistant syringe 721 is desirably configured using, for example, heat resistant glass or heat resistant metal. Note that, for a reduction of diffusion of heat, burn prevention, and the like, it is desirable to adopt a configuration in which the outer circumferential surface of the heat resistant syringe 721 is covered with a heat insulating material.

The proximal end portion of the heat resistant syringe 721 is connected to the compressor 71. The gas supplied from the compressor 71 is led into the inside of the heat resistant syringe 721 from the proximal end portion. The distal end portion (the end portion opposed to the stage 2) of the heat resistant syringe 721 configures a nozzle formed in a shape, a cylindrical diameter dimension of which decreases toward the distal end. A nozzle opening section 721A, from which the heated gas is emitted, is provided at the distal end of the nozzle.

The winding core 722 made of, for example, ceramic is disposed on the center axis of the heat resistant syringe 721. The heater coil 723 is wound on the winding core 722. The heater coil 723 is heated by feeding an electric current under the control by the controller 5. The heater coil 723 heats the gas led into the heat resistant syringe 721. As the heater coil 723, for example, a heating wire of nickel chrome or iron chrome aluminum can be used. It is possible to perform high-temperature heating at temperature equal to or higher than 1000° C. Therefore, even when a metal material is used as the molding material 10, it is possible to melt and laminate the metal material.

The temperature sensor 724 is provided at the distal end on the nozzle side of the winding core 722. The temperature sensor 724 measures the temperature of the heated gas emitted from the nozzle opening section 721A. The temperature sensor 724 is electrically connected to the controller 5. The temperature sensor 724 outputs a detection signal corresponding to the measured temperature to the controller 5. Consequently, the controller 5 can control an applied voltage to the heater coil 723 on the basis of the measured temperature and emit the heated gas having a desired temperature from the nozzle opening section 721A.

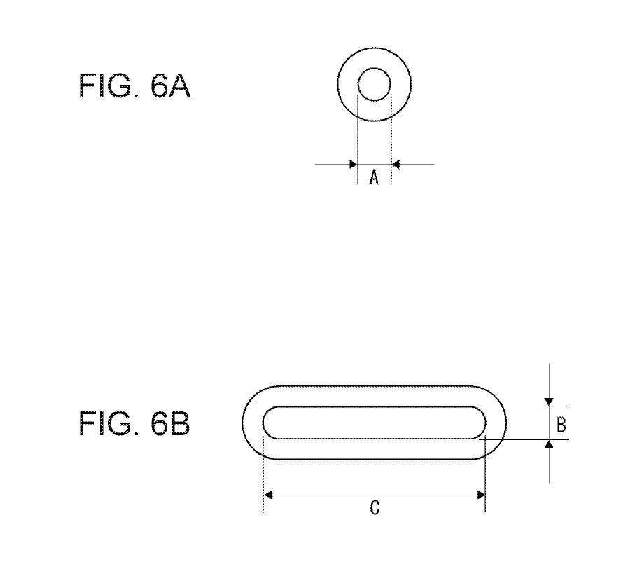

FIG. 6 is a diagram showing the shape of the nozzle opening section 721A in the heat resistant syringe 721.

The distal end shape of the nozzle opening section 721A is desirably formed in a shape with which turbulence or the like less easily occurs in the emitted heated gas and the heated gas is appropriately blown against the molding material 10 on the desired molding position P.

As such an opening shape of the nozzle opening section 721A, for example, a circular shape shown in FIG. 6(A) or an elliptical shape shown in FIG. 6(B) can be illustrated.

In the shape shown in FIG. 6(A), the heated gas can be locally blown against a part in the tape width direction of the tape-like molding material 10. It is possible to form a molded object at high accuracy. In this case, it is desirable to set the opening diameter dimension A to, for example, 0.05 mm≦A≦2.

On the other hand, in the case of the shape shown in FIG. 6(B), for example, it is possible to blow the heated gas against a wide range of the molding material 10. Therefore, the shape is suitable when the molded object is molded at high speed. In this case, when a short diameter dimension of the nozzle opening section 721A is represented as B and a long diameter dimension of the nozzle opening section 721A is represented as C, it is desirable to set the short diameter dimension B and the long diameter dimension C to, for example, 0.1 mm≦B≦1 mm and C≦10B.

Incidentally, in this embodiment, the heated gas is blown against a part of the tape width dimension in the tape-like molding material 10 to melt the part in the tape width direction and mold a molded object. In this case, by configuring the gas supplying section 72 to be capable of being scanned with respect to the tape width direction, it is possible to consume the tape-like molding material 10 without waste.

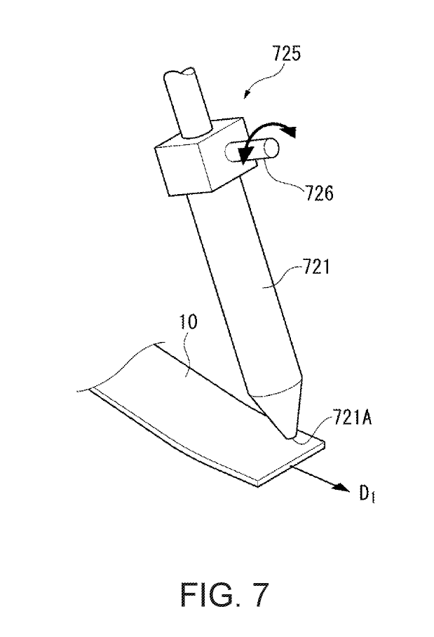

In FIG. 7, a configuration example of a swinging section for scanning the gas supplying section 72 in the tape width direction is shown.

In the example shown in FIG. 7, a swinging section 725 is provided at the proximal end portion of the gas supplying section 72. The swinging section 725 includes a swinging shaft 726 that is parallel to the tape conveying direction D₁ in the molding position P in plan view from the normal direction D₂ of the stage 2 and inclines with respect to the normal direction D₂ of the stage 2 in plan view from the tape width direction (see FIG. 1). The swinging shaft 726 is axially supported by a main body section (not shown in the figure) of the molding head 3 such that the heat resistant syringe 721 is capable of swinging along the tape width direction orthogonal to the tape conveying direction. As a swinging motion of the gas supplying section 72 by the swinging section 725, for example, power from a power source such as a stepping motor is transmitted to the swinging shaft 726 to swing the swinging shaft 726. By controlling the operation of the power source with the controller 5, it is possible to blow the heated gas against a predetermined position in the tape width direction.

Note that the swinging section that swings the gas supplying section 72 is not limited to the above. Besides, any configuration may be used. For example, a configuration may be adopted in which the gas supplying section 72 is capable of translating in the tape width direction in the molding head 3. For example, the swinging section may be configured to be advanced and retracted in the tape width direction with a moving mechanism separately provided.

### (Configuration of the Duct 73)

In the duct 73, a gas suction port is provided in the vicinity of the molding position P. The duct 73 collects the heated gas emitted from the gas supplying section 72 and blown against the molding material 10.

In this embodiment, the gas supplying section 72 blows the heated gas from the upstream side toward the downstream side in the conveying direction. Therefore, the duct 73 is desirably disposed on the downstream side of the gas supplying section 72.

The duct 73 is connected to the compressor 71. The duct sucks a substrate with a gas absorbing force by the compressor 71. In such a configuration, the heated gas is circulated and utilized by the compressor 71, the gas supplying section 72, and the duct 73. Energy efficiency is improved.

A channel sectional area of the suction port of the duct 73 is desirably larger than an opening area of the nozzle opening section 721A of the gas supplying section 72. In such a configuration, it is possible to collect, with the duct 73, gas more than the blown heated gas. It is possible to improve collection efficiency of the heated gas.

### [Configuration of the Moving Mechanism 4]

The moving mechanism 4 moves the molding head 3 in axial directions of an X axis, a Y axis, and a Z axis with respect to the stage 2 and moves a conveyance destination (the molding position P) of the molding material 10 of the tape conveying mechanism 6 in the molding head 3 and a blowing position of the heated gas of the hot-air blowing mechanism 7 to desired positions. That is, the moving mechanism 4 moves the molding position P with respect to the stage 2.

As a specific configuration, for example, a configuration can be illustrated in which the moving mechanism 4 includes a column capable of moving on a Y guide laid along the Y-axis direction, a slider including an X guide provided on the column and including an X guide extending in the X-axis direction, and a column capable of moving along the X guide and including a Z guide extending along the Z direction and the molding head 3 is provided to be capable of moving along the Z guide of the column. A configuration may be adopted in which a plurality of arm members are coupled and a coupling angle of arms is controlled to make it possible to move the molding head 3 in a three-dimensional space.

In this embodiment, a configuration is illustrated in which the molding head 3 is moved with respect to the stage 2 by the moving mechanism 4. However, the present invention is not limited to this. For example, a configuration may be adopted in which the stage 2 is moved with respect to the molding head 3. Further, for example, a configuration may be adopted in which the stage 2 is moved along the Z direction and the molding head 3 is moved along the X and Y axes.

### [Configuration of the Controller 5]

The controller 5 is configured by a storing section such as a memory, an arithmetic circuit such as a CPU, and the like. The controller 5 controls the entire operation of the molding apparatus 1. In the storage circuit, various programs and various data for controlling the molding apparatus 1 are recorded. The arithmetic circuit of the controller 5 reads and executes the programs stored in the storing section to function as data acquiring means 51, movement control means 52, and molding control means 53 as shown in FIG. 1. Note that, in this embodiment, an example is explained in which the functional components are realized by cooperation of an arithmetic circuit, which is hardware, and programs (software). However, for example, a configuration may be adopted in which the functional components are realized by combining integrated circuits (hardware) having the functions.

The data acquiring means 51 acquires data for molding from an external apparatus such as a personal computer communicably connected to the controller 5. Note that, for example, a configuration may be adopted in which the controller 5 includes a drive device that reads a recording medium and the controller 5 directly acquires data for molding from the recording medium mounted on the drive device.

The movement control means 52 controls the moving mechanism 4 on the basis of the data for molding to move the molding head 3.

The molding control means 53 controls the molding head 3. Specifically, the molding control means 53 controls the feeding section 62 and feeds the molding material 10 to the molding position P. The molding control means 53 controls the operations of the compressor 71, the gas supplying section 72, and the duct 73, melts and laminates the molding material 10 in the molding position P, and molds a molded object.

### [Manufacturing Method for a Molded Object by the Molding Apparatus 1]

A molding method for molding a molded object using the molding apparatus 1 explained above is explained below with reference to the drawings.

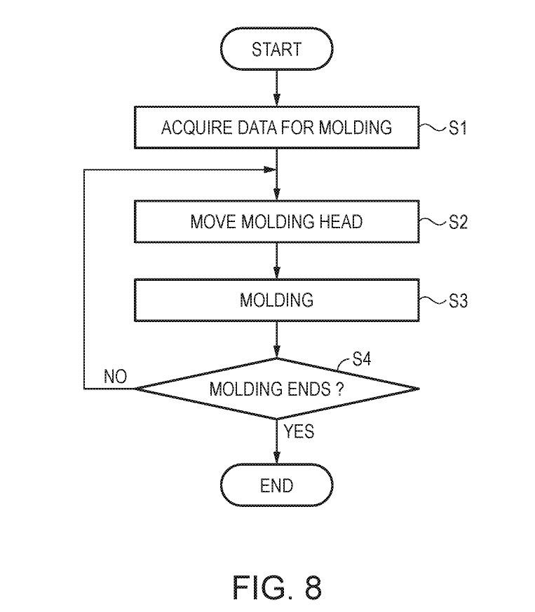

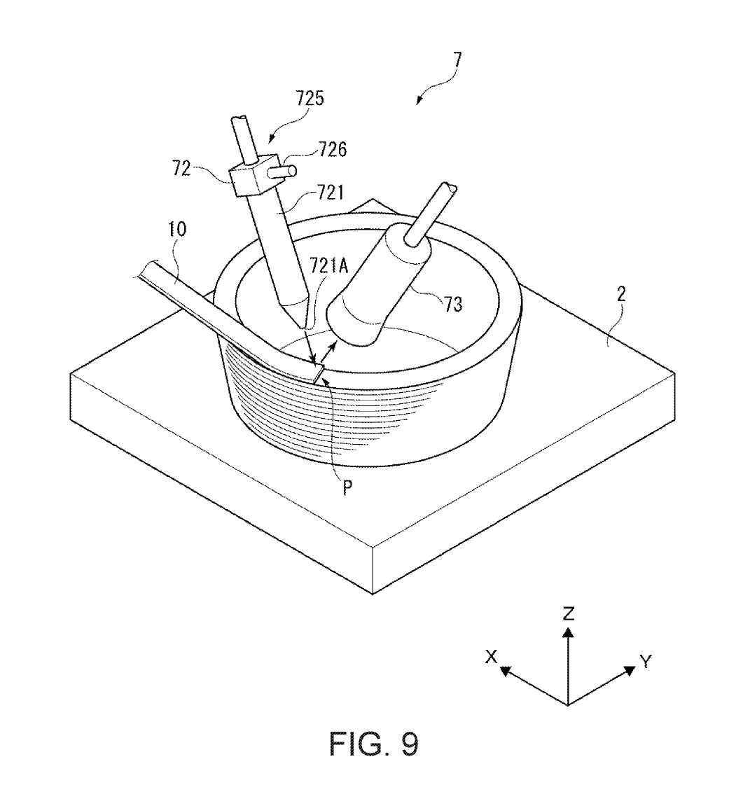

FIG. 8 is a flowchart showing the molding method (molding processing) for molding a molded object using the molding apparatus 1 in this embodiment. FIG. 9 is a perspective view showing a process in which a molded object is formed by the molding processing.

To mold a molded object with the molding apparatus 1, first, the data acquiring means 51 of the controller 5 acquires data for molding (step S1). Specifically, the data acquiring means 51 acquires, on the basis of operation by an operator, for example, data for molding input from an external apparatus such as a personal computer connected to the controller 5, data for molding recorded in a recording medium such as a CD-ROM, and data for molding acquired via a communication line such as the Internet.

Subsequently, the movement control means 52 analyzes a sectional shape of the molded object from the data for molding. As shown in FIG. 9, the movement control means 52 moves the molding head 3 to the molding position P equivalent to a molded object cross section (step S2).

Specifically, the movement control means 52 controls the moving mechanism 4 and the swinging section 725 of the gas supplying section 72 such that the distal end portion of the molding material 10 conveyed by the tape conveying mechanism 6 is located in the molding position P indicated on the basis of the data for molding.

Thereafter, the molding control means 53 controls the molding head 3 and the like to melt and laminate the molding material 10 in the molding position P and forms the molded object as shown in FIG. 9 (step S3).

Specifically, the molding control means 53 controls the compressor 71 and leads gas into the gas supplying section 72 from the compressor 71 to have a flow rate set in advance.

The molding control means 53 applies a voltage to the heater coil 723 referring to temperature detected by the temperature sensor 724 such that the detected temperature rises to temperature near a melting point of the molding material 10. Consequently, heated gas having temperature around the melding point of the molding material 10 is blown against a part of the tape width direction at the distal end portion of the molding material 10 from the nozzle opening section 721A. The molding material 10 is melted and laminated in the molding position P.

Thereafter, the molding control means 53 determines whether the molding processing for the molded object based on the data for molding is completed (step S4).

If it is determined “No” in step S4, the processing returns to step S2 and step S3. The movement of the molding head 3 and the melting and lamination of the molding material are repeated.

In this case, the movement control means 52 controls the swinging section 725 of the gas supplying section 72 to move a blowing position of the heated gas of the gas supplying section 72 along the tape width direction and move the moving mechanism 4 and controls the position of the molding head 3 such that the blowing position of the heated gas becomes the molding position P based on the data for molding.

When the blowing position of the heated gas is scanned by the swinging section 725 and the molding material 10 along the tape width direction is melted and laminated, the molding control means 53 drives the driving roller 622A of the tape conveying mechanism 6 to feed the molding material 10 to the molding position P. The molding control means 53 controls the feeding section 62 to drive the driving roller pair 622 and feeds the molding material 10 by a predetermined amount. The molding material 10 fed by the feeding section 62 bends with own weight because the molding material 10 has flexibility. The molding material 10 is urged to and brought into contact with the molding position P. Thereafter, as in step S3, the molding control means 53 melts and laminates the molding material 10 in the molding position P.

If it is determined “Yes” in step S4, the molding control means 53 ends the molding processing.

Thereafter, the molding control means 53 determines whether the molding processing for the molded object based on the data for molding is completed (step S4).

If it is determined “No” in step S4, the processing returns to step S2 and step S3. The movement of the molding head 3 and the melting and lamination of the molding material are repeated.

In this case, the movement control means 52 controls the swinging section 725 of the gas supplying section 72 to move the blowing position of the heated gas of the gas supplying section 72 along the tape width direction and move the moving mechanism 4 and controls the position of the molding head 3 such that the blowing position of the heated gas becomes the molding position P based on the data for molding.

When the blowing position of the heated gas is scanned by the swinging section 725 and the molding material 10 along the tape width direction is melted and laminated, the molding control means 53 drives the driving roller 622A of the tape conveying mechanism 6 to feed the molding material 10 to the molding position P. The molding material 10 fed by the feeding section 62 bends with own weight because the molding material 10 has flexibility. The molding material 10 is urged to and brought into contact with the molding position P. Thereafter, as in step S3, the molding material 10 is melted and laminated in the molding position P.

If it is determined “Yes” in step S4, the molding control means 53 ends the molding processing.

[Action and Effect of this Embodiment]

In the molding apparatus 1 in this embodiment, the tape-like molding material 10 having the rectangular shape in section is wound in the concentric shape on the bobbin 616. Consequently, it is possible to bring the tape rear surface and the tape front surface close to each other and wind the molding material 10 on the bobbin 616. Therefore, for example, compared with when a thread-like or string-like molding material having a circular shape in section is used and wound on a winding core, it is possible to increase a volume occupancy ratio. That is, when the same amount of the molding material is stored in the cassette 61, compared with the molding material having the circular shape in section, it is possible to achieve a reduction in the size of the cassette 61. In other words, when a size of the cassette 61 is fixed, compared with when the molding material having the circular shape in section is used, it is possible to wind a larger amount of the molding material 10 on the bobbin. There is also a configuration in which powder is used as a molding material. However, such powder has a spherical shape. Therefore, like the molding material having the circular shape in section, a volume occupancy ratio at the time when the powder is stored in the cassette 61 is small. Further, it is necessary to provide a lid section or the like that closes the feeding port 614A of the cassette. On the other hand, in the molding material 10 in this embodiment, it is possible to set the volume occupancy ratio larger than the volume occupancy ratio of the molding material of the powder, it is unnecessary to provide a lid section in the feeding port 614A, and it is easy to handle the molding material 10.

The molding material 10 is formed in the tape shape having the rectangular shape in section. Such a tape-like molding material 10 has a uniform thickness dimension. Therefore, the thickness of the molding material 10 laminated in the molding position P does not fluctuate. It is possible to mold a highly precise molded object.

In this embodiment, the molding material 10 and the bobbin 616 are housed in the case 611. Consequently, it is possible to suppress the molding material 10 wound on the bobbin 616 from getting loose against an intention of the user. It is possible to improve handleability. Further, it is possible to easily perform replacement and supply of the molding material 10 by attaching and detaching the case 611 to and from the molding apparatus 1.

In this embodiment, with the first contact surface section 613B and the second contact surface section 615A disposed across the bobbin 616 in the width direction of the molding material 10, it is possible to regulate movement of the molding material 10 in the width direction. Consequently, it is possible to suppress positional deviation in the width direction of the molding material 10 due to rotation of the bobbin 616. It is possible to stably supply the molding material 10.

In this embodiment, the case 611 includes the guide surface section 613C that guides the end edge in the tape width direction of the molding material 10. Consequently, it is possible to regulate movement of the molding material 10 in the width direction. It is possible to stabilize a feeding direction of the molding material 10 fed from the cassette 61.

Further, in this embodiment, the rotating shafts 618A of the guide rollers 618 are further inclined to the conveying direction side with respect to the normal direction N of the guide surface section 613C as the rotating shafts 618A are further away from the guide surface section 613C. Consequently, it is possible to feed, with the guide rollers 618, the molding material 10 in a state in which the edge portion of the molding material 10 is placed along the guide surface section 613C. It is possible to use, as a regulating section that regulates movement of the molding material 10, the guide surface section 613C provided integrally on the inner surface 613A of the case 611. Another member such as a guide member does not have to be provided. It is possible to achieve a reduction in the number of components and simplification of a configuration.

In this embodiment, the cassette 61 includes the rotation suppressing section 617 that suppresses rotation of the bobbin 616. In such a configuration, it is possible to suppress idling of the bobbin 616. It is possible to suppress an inconvenience that the molding material 10 is unintentionally fed from the feeding port 614A.

In the molding material 10 wound on the bobbin 616, the strength of the winding curl is different according to the distance from the center axis of the bobbin 616. Concerning such fluctuation in the winding curl, in this embodiment, it is possible to adjust the winding curl with the winding-curl adjustment guide 619. Consequently, for example, in the molding apparatus 1, it is possible to adjust the strength of the winding curl in an allowable range in which the winding curl does not hinder stable conveyance of the molding material 10. Therefore, it is possible to suppress deterioration in conveyance stability doe to the fluctuation in the strength of the winding curl. It is possible to stably convey and supply the molding material 10.

In particular, in this embodiment, the winding-curl adjustment guide 619 includes the contact surface 619A with which the tape rear surface of the molding material 10 is set in contact in a predetermined distance (in this embodiment, between the end portion 619B and the end portion 619C). Consequently, while the molding material 10 is conveyed along the contact surface 619A, it is possible to adjust the strength of the winding curl to strength corresponding to a surface shape of the contact surface 619A.

Further, in this embodiment, the winding-curl adjustment guide 619 includes the contact surface 619A set to the predetermined curvature in the conveying direction of the molding material 10. By conveying the molding material 10 in a state in which the molding material 10 is set in contact with the contact surface 619A, it is possible to adjust the strength of the winding curl to strength corresponding to the curvature. Consequently, it is possible to more surely adjust the strength of the winding curl.

In this embodiment, the aspect ratio (a/b), which is the ratio of the tape thickness dimension “a” and the tape width dimension “b”, of the tape-like molding material 10 is equal to or larger than 10. When the aspect ratio is smaller than 10, it is conceivable that the tape thickness dimension is too large with respect to the tape width dimension or the tape width dimension is too small with respect to the tape thickness dimension. In the former case, since the flexibility of the molding material 10 is insufficient and the tape thickness dimension is too large, sufficient flexibility is not obtained and conveyance handleability of the molding material 10 by the feeding section 62 is deteriorated. In the latter, a twist or the like occurs and the conveyance handleability is deteriorated. On the other hand, by setting the aspect ratio to be equal to or larger than 10 as explained above, it is possible to improve conveyance efficiency of the molding material 10 having the flexibility. It is possible to efficiently convey the molding material 10 to a desired molding position.

As the molding material 10 in this embodiment, it is possible to select a molding material made of metal or made of resin.

When the molding material 10 made of metal is used, it is possible to mold a molded object having high-durability quality compared with the molding material 10 made of resin. When the molding material 10 made of resin is used, compared with the molding material 10 made of metal, a heating temperature is low, it is possible to achieve further simplification of the configuration of the gas supplying section 72, and a further reduction in size is possible.

When the molding material 10 made of metal is used, it is possible to achieve a reduction in the weight of the molding material 10 by using Mg having small specific gravity. A molded object to be molded is also light in weight. When such metal is used, in order to suppress oxidation reaction by heating, flameproof treatment or fireproof treatment is applied to the metal. Consequently, it is possible to effectively suppress metal oxidation at the time when heated gas is blown against the metal. It is possible to prevent quality deterioration of the molded object due to degeneration.

In this embodiment, the molding material 10 is supplied and conveyed such that the tape rear surface (the surface on the bobbin 616 side) of the molding material 10 wound on the bobbin 616 is opposed to the stage 2. Consequently, the molding material 10 is conveyed to the molding position P on the stage 2 in a state in which the distal end of the molding material 10 has a winding curl in a direction toward the stage 2. Therefore, it is possible to suppress the molding material 10 from being turned up in the molding position P, that is, the distal end portion of the molding material 10 from separating from the stage 2 or a molded object on the stage 2. It is possible to suppress occurrence of a molding failure due to the turn-up.

In this embodiment, in the driving roller pair 622, the molding material 10 has the winding curl in a direction in which the molding material 10 winds around the driving roller 622A that is in contact with the surface on the bobbin 616 side of the molding material 10 wound on the bobbin 616. Consequently, the molding material 10 is urged by the driving roller 622A, it is possible to suppress a slip or the like during conveyance, and it is possible to improve conveyance efficiency.

A configuration may be adopted in which both of the pair of rollers configuring the driving roller pair 622 are driven as driving rollers. It is possible to correct the winding curl of the molding material by setting rotating speed of the driving roller 622A in contact with the surface on the bobbin 616 side (the tape rear surface) of the molding material 10 wound on the bobbin 616 higher than rotating speed of the other. That is, it is possible to cause stress in a direction in which the tape rear surface is extended in the conveying direction to correct the winding curl to act on the tape rear surface from the driving roller 622A. Therefore, it is possible to correct the winding curl of the molding material 10.

The molding apparatus 1 in this embodiment includes the stage 2 on which a molded object is molded, the tape conveying mechanism 6 that conveys the molding material 10 to the predetermined molding position P on the stage 2, the hot-air blowing mechanism 7 that blows heated gas against the molding material 10, which is conveyed to the molding position P, and melts the molding material 10, and the moving mechanism 4 that moves the molding head 3, in which the hot-air blowing mechanism 7 is incorporated, such that the molding position P is located in a desired position based on data for molding.

In such a configuration, the conveyance and the supply of the molding material 10 and the supply of the heated gas are carried out by separate mechanisms. Only a necessary part of the molding material 10 is locally melted by the heated gas. Therefore, for example, compared with when the melted molding material 10 is extruded and laminated in the molding position P, a melting amount and a melting area (volume) of the molding material 10 may be small and thermal energy may also be small. Therefore, it is possible to reduce the size of the configuration of the heating mechanism (the heater coil 723) in the gas supplying section 72. It is possible to achieve a reduction in the size and a reduction in manufacturing costs of the molding apparatus 1.

The molding material 10 conveyed by the tape conveying mechanism 6 is urged to and brought into contact with the molding position P and melted in the position. Therefore, the melted molding material 10 does not adhere to or remain in the tape conveying mechanism 6 and the hot-air blowing mechanism 7. Therefore, maintenance of the molding apparatus 1 is also easy.

### [Other Embodiments]

Note that the present invention is not limited to the embodiment explained above. Modifications, improvements, and the like within a range in which the object of the present invention can be achieved are included in the present invention.

In the embodiment, the configuration is illustrated in which the case 611 includes, as the guide sections that regulate the position in the width direction of the molding material 10, the first contact surface section 613B and the second contact surface section 615A provided in the base section 613. However, the present invention is not limited to this. A configuration may be adopted in which the case 611 includes only one of the first contact surface section 613B and the second contact surface section 615A.

In the embodiment, the configuration is illustrated in which the case 611 includes the guide surface section 613C. However, a configuration may be adopted in which the case 611 does not include the guide surface section 613C and the molding material 10 is conveyed along the inner surface of the case 611.

In the embodiment, the configuration is illustrated in which the winding-curl adjustment guide 619 is provided in the feeding port 614A. However, the present invention is not limited to this. For example, the winding-curl adjustment guide 619 only has to be provided on a conveyance route leading to the feeding port 614A. For example, the winding-curl adjustment guide 619 may be provided on a conveying direction upstream side of the guide rollers 618.

A configuration may be adopted in which the winding-curl adjustment guide 619 is projected to the outer side of the case 611 and provided further on a conveying direction downstream side than the feeding port 614A.

Guide rollers may be provided on both of the conveying direction upstream side and the conveying direction downstream side with respect to the winding-curl adjustment guide 619. Consequently, it is possible to more surely maintain a state in which the molding material 10 is set in contact with the contact surface 619A.

In the embodiment, the configuration is illustrated in which the winding-curl adjustment guide 619 includes the contact surface 619A made convex on the side in contact with the tape rear surface of the molding material 10. However, the winding-curl adjustment guide 619 may be a contact surface having a flat shape or having a curved surface convex to the opposite side. Note that a correction force of the winding curl can be increased more when the contact surface is formed in the flat shape than when the side in contact with the tape rear surface of the molding material 10 is made convex and increased more when the contact surface is made convex to the opposite side.

When the contact surface 619A is made convex to the opposite side of the side in the embodiment, by bringing the contact surface 619A into contact with the tape front surface of the molding material 10, it is possible to convey the molding material 10 in a state in which the molding material 10 is more surely placed along the contact surface 619A.

Further, a pressed member, against which the molding material 10 is pressed, may be disposed on the contact surface 619A of the winding-curl adjustment guide 619. Consequently, it is possible to convey the molding material 10 in a state in which the molding material 10 is more surely placed along the contact surface 619A. Note that, as the pressed member, a roller or a guide member disposed to be opposed to the contact surface 619A can be illustrated.

In the embodiment, the winding-curl adjustment guide 619 is illustrated as the winding-curl adjusting section of the present invention. However, the present invention is not limited to this. For example, a configuration may be adopted in which an opposed surface opposed to the contact surface 619A is provided and the molding material 10 is caused to pass between the contact surface 619A and the opposed surface. A configuration may be adopted in which the winding curl is adjusted by differentiating the rotating speeds of the pair of driving rollers as explained above. Note that, in the embodiment, the configuration is illustrated in which the winding-curl adjustment guide 619 is provided as the winding-curl adjusting section. However, a configuration may be adopted in which the winding-curl adjusting section is not provided.

In the embodiment, the configuration is illustrated in which, as shown in FIG. 3, the guide rollers 618 are disposed on the tangential line at the end portion 619B when viewed in the tape width direction. However, the present invention is not limited to this. For example, the guide rollers 618 do not have to be disposed on the tangential line at the end portion 619B. The guide rollers 618 may be disposed further on the curvature center O side of the contact surface 619A than the tangential line at the end portion 619B. In this case, since the molding material 10 is guided further to the curvature center O side than the contact surface 619A, it is possible to more surely maintain a state in which the molding material 10 is set in contact with the end portion 619B. It is possible to curve the molding material 10 (i.e., reversely curve the molding material 10 to be convex on the tape rear surfaced side) in a direction in which the winding curl is corrected. Consequently, it is possible to bring the molding material 10 after the strong correction of the winding curl into contact with the contact surface 619A. It is possible to more surely adjust the winding curl.

In the embodiment, the guide rollers 618 are inclined with respect to the conveying direction to be pressed against the inner surface of the case 611. However, the present invention is not limited to this. For example, a configuration may be adopted in which a guide opposed to the inner surface 613A of the case 611 is provided instead of the guide rollers 618 and the molding material 10 is conveyed along the inner surface by the guide.

Note that the rotation suppressing section 617 is not limited to the cylindrical configuration. A part of the rotation suppressing section 617 only has to be in contact with the side surface of the bobbin 616 and apply a frictional force to the side surface. Therefore, for example, a configuration may be adopted in which the rotation suppressing section 617 having a rectangular parallelepiped shape is provided with respect to the lid body 615. In this embodiment, the rotation suppressing section 617 is configured to suppress idling of the bobbin 616 with a frictional force. However, for example, a configuration may be adopted in which an urging force toward the center side of the bobbin 616 is applied to the tape front surface of the molding material 10 wound on the bobbin 616. Besides, various configurations for suppressing idling of the bobbin 616 may be adopted.

In the embodiment, the hot-air blowing mechanism 7 is illustrated as the melting mechanism that melts the molding material 10. However, the present invention is not limited to this. For example, a mechanism for melting the molding material 10 with, for example, a laser radiating mechanism that radiates a laser beam or an electric discharge mechanism that generates electric discharge may be adopted. A mechanism for bringing a high-temperature wire into contact with the molding material 10 and heating and melting a contact portion may be adopted. That is, various melting mechanisms capable of locally melting the molding material 10 can be used.

In the embodiment, the tape-like material having the rectangular shape in section, the aspect ratio of which is equal to or larger than 10, is illustrated as the molding material 10. However, the present invention is not limited to this. A tape-like material, the aspect ratio of which is smaller than 10, may be used as long as, depending on, for example, the quality of the molding material 10, the molding material 10 has sufficient flexibility and conveyance handleability of the molding material 10 in the tape-conveying mechanism 6 is satisfactory.

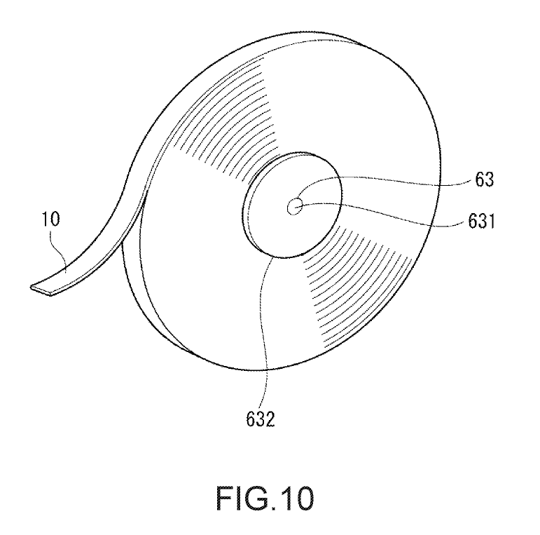

In the embodiment, the molding material 10 is configured to be stored in the cassette 61. However, the present invention is not limited to this. For example, as shown in FIG. 10, the molding material 10 may be retained in a roll shape by winding the molding material 10 on a shaft core 63. In this case, it is possible to mount the shaft core 63, on which the molding material 10 is wound, on the molding head 3 by providing a mounting hole 631 along the center axis of the shaft core 63 and inserting, for example, a locking pin provided in the molding head 3 through the mounting hole 631. It is possible to prevent slack or the like of the molding material 10 by adopting a configuration in which brim sections 632, which hold both end edges in the tape width direction of the molding material 10, are provided at both end portions in the axial direction of the shaft core 63.

Besides, a specific structure in carrying out the present invention can be changed to other structures and the like as appropriate in a range in which the object of the present invention can be achieved.

### REFERENCE SIGNS LIST

1 molding apparatus
2 stage
4 moving mechanism
7 hot-air blowing mechanism (melting mechanism)
10 molding material
61 cassette (molding-material supplying mechanism)
62 feeding section (feeding mechanism)
63 shaft core (winding core)
611 case (housing)
613B first contact surface section (contact surface section)
613C guide surface section
614A feeding port
615A second contact surface section (contact surface section)
616 bobbin (winding core)
617 rotation suppressing section
618 guide roller (guide member)
618A rotating shaft
619 winding-curl adjustment guide (winding-curl adjusting section)
619A contact surface
622 driving roller pair (pair of rollers)
622A driving roller
622B driven roller
623 guide section
631 mounting hole
632 brim section

1. A molding-material supplying mechanism comprising:
a tape-like molding material having a rectangular shape in section; and
a winding core on which the molding material is wound, wherein
in sectional view orthogonal to a shaft of the winding core, the molding material is wound on the winding core in a concentric shape centering on the shaft.

2. The molding-material supplying mechanism according to claim 1, further comprising a brim section provided in at least one of both end portions in an axial direction of the winding core, an end edge in a tape width direction of the molding material coming into contact with the brim section.

3. The molding-material supplying mechanism according to claim 1, further comprising a rotation suppressing section that suppresses rotation of the winding core.

4-15. (canceled)

16. The molding-material supplying mechanism according to claim 2, further comprising a rotation suppressing section that suppresses rotation of the winding core.

17. The molding-material supplying mechanism according to claim 1, further comprising a housing that houses the molding material and the winding core.

18. The molding-material supplying mechanism according to claim 2, further comprising a housing that houses the molding material and the winding core.

19. The molding-material supplying mechanism according to claim 17, wherein the housing includes a contact surface section to which the shaft of the winding core is turnably attached, the contact surface section being orthogonal to the shaft of the winding core and an end edge in a tape width direction of the molding material coming into contact with the contact surface section.

20. The molding-material supplying mechanism according to claim 17, further comprising a guide member that guides the molding material drawn out from the winding core, wherein
the housing includes a feeding port for feeding the molding material to an outside of the housing and a guide surface section provided between the guide member and the feeding port on an inner surface of the housing, and
the guide member guides the molding material in a direction in which an end edge in a tape width direction of the molding material is brought into contact with the guide surface section.

21. The molding-material supplying mechanism according to claim 19, further comprising a guide member that guides the molding material drawn out from the winding core, wherein
the housing includes a feeding port for feeding the molding material to an outside of the housing and a guide surface section provided between the guide member and the feeding port on an inner surface of the housing, and
the guide member guides the molding material in a direction in which an end edge in a tape width direction of the molding material is brought into contact with the guide surface section.

22. The molding-material supplying mechanism according to claim 20, wherein
the guide member is a guide roller having an outer circumference columnar shape capable of rotating about a rotating shaft, the guide roller rotating in a state in which a surface orthogonal to a tape thickness direction of the molding material is set in contact with an outer circumferential surface to guide the molding material in a direction in which the molding material is brought into contact with the guide surface section, and
the rotating shaft inclines from a normal direction of the guide surface section to a conveying direction side in which the molding material is conveyed to the feeding port side.

23. The molding-material supplying mechanism according to claim 1, further comprising a winding-curl adjusting section that adjusts a winding curl of the molding material.

24. The molding-material supplying mechanism according to claim 2, further comprising a winding-curl adjusting section that adjusts a winding curl of the molding material.

25. The molding-material supplying mechanism according to claim 23, wherein the winding-curl adjusting section includes a contact surface with which a surface orthogonal to a thickness direction of the molding material comes into contact in a predetermined distance along a conveying direction.

26. The molding-material supplying mechanism according to claim 25, wherein the contact surface has a predetermined curvature with respect to the conveying direction of the molding material.

27. The molding-material supplying mechanism according to claim 1, wherein the molding material has flexibility, and an aspect ratio of a tape thickness dimension and a tape width dimension in sectional view is equal to or larger than 10.

28. The molding-material supplying mechanism according to claim 2, wherein the molding material has flexibility, and an aspect ratio of a tape thickness dimension and a tape width dimension in sectional view is equal to or larger than 10.

29. A molding apparatus comprising:
a molding-material supplying mechanism that supplies a molding material;
a feeding mechanism that conveys the molding material to a molding position on a stage;
a melting mechanism that melts the molding material conveyed to the molding position; and
a moving mechanism that moves the molding position relatively to the stage, wherein
the molding-material supplying mechanism includes:
a tape-like molding material having a rectangular shape in section; and
a winding core on which the molding material is wound, and
in sectional view orthogonal to a shaft of the winding core, the molding material is wound on the winding core in a concentric shape centering on the shaft.

30. The molding apparatus according to claim 29, wherein the feeding mechanism conveys the molding material to the molding position with a surface on the winding core side in the molding material, which is wound on the winding core, opposed to the stage side.

31. The molding apparatus according to claim 29, wherein
the feeding mechanism includes a pair of rollers that holds and conveys the molding material, and
of the pair of rollers, one roller in contact with a surface on the winding core side of the molding material wound on the winding core is driven to rotate.

32. The molding apparatus according to claim 29, wherein
the molding-material supplying mechanism includes a pair of rollers that holds and conveys the molding material,
the pair of rollers is driven to rotate, and
of the pair of rollers, one roller in contact with a surface on the winding core side of the molding material wound on the winding core has rotating speed higher than rotating speed of the other roller in contact with a surface on the opposite side of the winding core of the molding material wound on the winding core.
